(19) United States
(12) Patent Application Publication
(10) Pub. No.: US 2006/0040748 A1
(43) Pub. Date: Feb. 23, 2006

(54) Branching storyline game

(76) Inventor: Mark Barthold, Torrance, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/206,924

(22) Filed: Aug. 17, 2005

Related U.S. Application Data
(60) Provisional application No. 60/603,029, filed on Aug. 19, 2004.

(51) Int. Cl. A63F 13/00

(52) U.S. Cl. 463/43; 273/292

(57) ABSTRACT

A storytelling game is disclosed, including game components and rules for playing a game for at least one player. The goal of the storytelling game is to work through a story to a successful ending by choosing among possible story directions at story branch points. The game may include the use of an electronic card reader and multiple story cards. At least one of the story cards may contain an embedded digital memory. Several chapters in an extended story may be provided by several card sets, which may be obtained independently.

### CROSS-REFERENCE TO RELATED APPLICATIONS

This application is based upon and claims priority under 35 U.S.C. §119(e) to U.S. Provisional Patent Application Ser. No. 60/603,029, filed Aug. 19, 2004. U.S. Provisional Patent Application Ser. No. 60/603,029 is incorporated herein by reference in its entirety for all purposes.

### FIELD OF THE DISCLOSURE

The present disclosure relates generally to storytelling games and devices useable for playing such games. An object of a storytelling game may be for the player or players to reach an ultimate story ending by making choices at branching points in a storyline.

### BACKGROUND OF THE DISCLOSURE

Examples of games, including storyline games, are disclosed in U.S. patents and Patent Application Publications numbered: U.S. Pat. Nos. 305,018; 584,801; 644,623; 739,678; 807,433; 836,537; 1,057,892; 1,716,069; 2,099,611; 3,603,593; 3,749,406; 4,050,698; 4,222,571; 4,637,799; 4,741,540; 4,747,600; 4,764,666; 5,318,306; 5,374,061; 5,401,032; 5,737,527; 5,751,953; 5,841,741; 5,863,043; 5,872,927; 6,059,291; 6,108,515; 6,200,216; 6,318,723; 6,412,779; 6,474,650; 6,638,161; 6,676,126; US2001/0039206; US2002/0060426; US2003/0067117; US2003/0155714; US2003/0227136; and US2004/0002387. Another example of an apparatus embodying some aspects of a storyline game may be found in European Patent Publication WO 01/63,442. An example of a branching storyline may be found in the “Choose Your Own Adventure” line of books available from Bantam Books and ChooseCo. The disclosures of the aforementioned patents, patent publications and prior art books are incorporated herein by reference in their entirety for all purposes.

### SUMMARY

A branching storyline game may utilize an electronic card reader, a plurality of standard cards, and one or more enhanced cards configured to interface with the electronic card reader. The electronic card reader may be configured to engage removably a suitably-sized enhanced card and to read data stored thereupon. In addition, the electronic card reader may be configured to convert data residing on an enhanced card into output suitable for comprehension by a player of the branching storyline game. The enhanced card may be configured to store data in a form such that it may be read by the electronic card reader. The data on the enhanced card may be configured to present a story embodied on the standard cards. The standard cards may be configured to present different portions of a story, with the portions being presented at the direction of the electronic card reader, utilizing the data embodied in the enhanced card.

The present disclosure will be understood more readily after consideration of the drawings and the Detailed Description.

### BRIEF DESCRIPTION OF THE DRAWINGS

FIG. 1 depicts one embodiment of an amusement system of the present disclosure.

FIG. 2 depicts one embodiment of a card reader suitable for use with the amusement system of the present disclosure.

FIGS. 3A and 3B depict embodiments of standard and enhanced cards for use with the amusement system of the present disclosure.

### DETAILED DESCRIPTION

A card reader may provide for an interactive branching storyline game utilizing a card reader, a plurality of standard cards, and one or more enhanced cards. In some examples, a card reader may provide for storage of a set of cards used in a branching storyline game, each set having a plurality of standard cards and one or more enhanced cards.

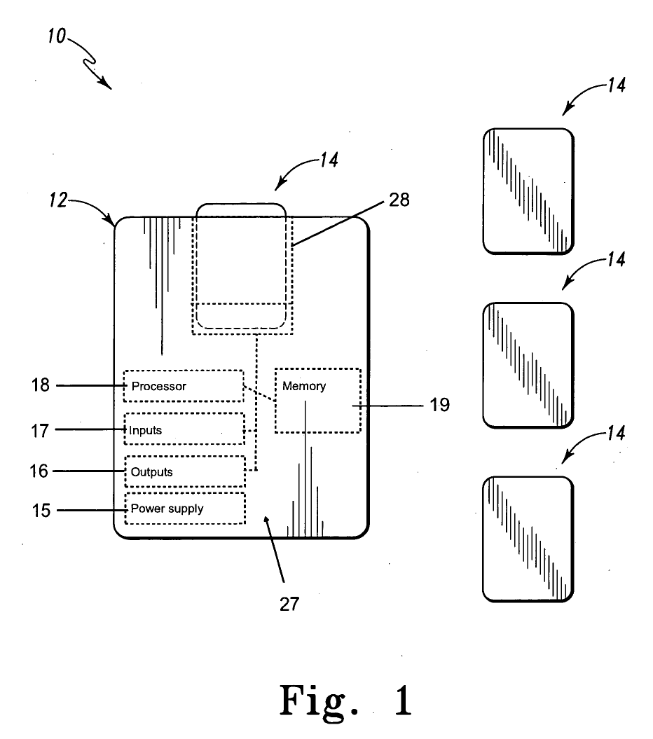

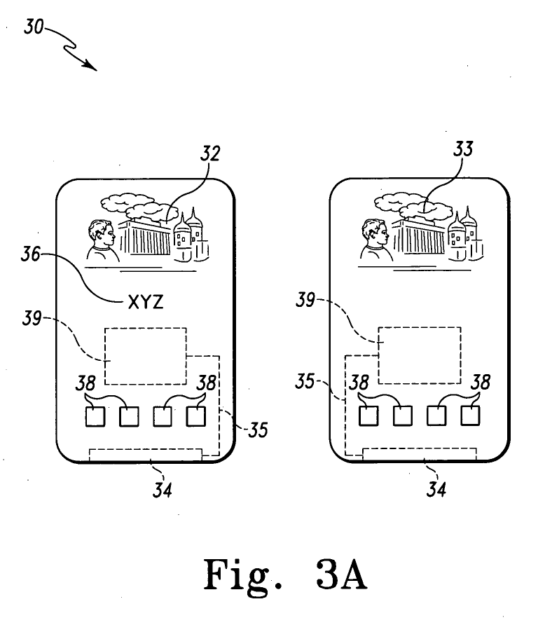

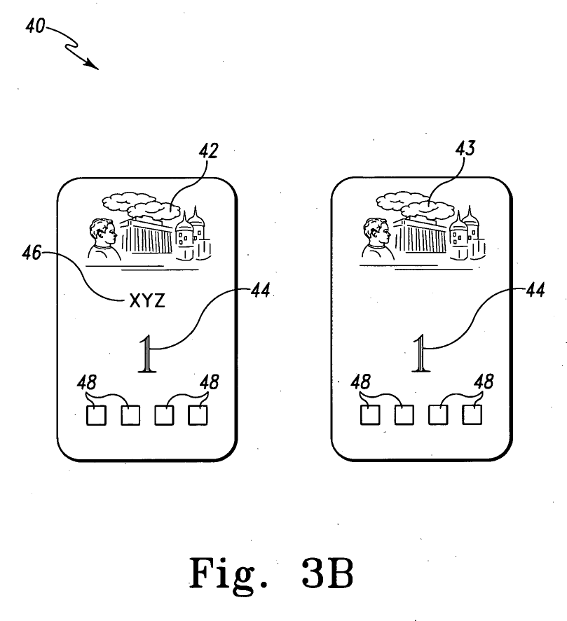

FIG. 1 shows generally at 10 game components for a game The game components may include a card reader 12 and game cards 14. The card reader 12 may be configured with further components that allow it to access and process data stored on a subset of game cards 14. Such components might include, for example, a power supply 15, information outputs and inputs, 16, 17, one or more processors 18, and a memory 19, among others. Such components, together, may make up at least a portion of internal electrical components 27. The card reader may process stored card data and convert that data to a form comprehensible by a person playing the game. In the course of play, the game player may make game-related decisions with the information derived from the stored data. Game cards 14 may include both enhanced cards 30 (seen in FIG. 3A), which may also be called a “data card,” and standard cards 40 (shown in FIG. 3B), which may also be called “indicia cards.” Enhanced cards may contain some or all of a text component, an icon, and an image, as well as data stored in a form that may be accessible by the card reader. Standard cards may contain some or all of a text component, an icon, and an image.

In other words, a set of components for relating a story with a branching storyline may include an electronic card reader unit 12 with a processor 18 and a memory 19, and a set of cards 14 for use with the electronic card reader unit. The set of cards may include both standard cards 30, and at least one card, enhanced card 40, having an integral memory upon which game data may be stored.

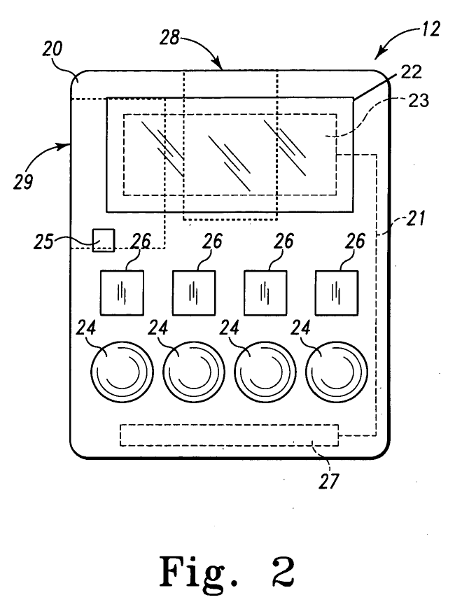

FIG. 2 shows in more detail one embodiment of a card reader 12. A body 20 of the card reader may have a display window 22, one or more game buttons 24, button display windows 26 associated with the game buttons, an audio output 25, internal electrical and/or optical components 27 forming part of a circuit 21, one or more activation slots 28, and one or more storage compartments 29. The card reader may also have other appropriate features, not shown, such as one or more volume controllers, one or more memory recall or repeat buttons, a reset button, or the like. One or more types of power supply 15 may be used to power internal electrical components 27 of the card reader, including an A/C adapter, one or more batteries, etc. For example, card reader 12 may primarily receive power from a plurality of batteries.

Storage compartment 29 may be designed such that it may hold one or a plurality of game cards when the cards are not in use. If the game cards have been configured with a common size and shape, then the storage compartment may conveniently be configured to accommodate a desired number of those cards. The storage compartment 29 may also be configured to store any number of other items, in addition to or instead of game cards 14. For example, storage compartment 29 may be configured to store a user's listening device (such as a pair of headphones), or a replacement supply of electrical power (perhaps batteries or an electrical adapter), or other items of use in a game of the present disclosure. In an illustrated embodiment of the present disclosure, the card reader may have a storage compartment 29 designed to hold all the game cards needed to play a branching storyline game.

Storage compartment 29 may have an unobstructed opening to the exterior of a card reader body 20, or the storage compartment may have a door covering that opening. If present, a door which covers the opening of storage compartment 29 may function to keep a set of game cards contained within card reader body 20 or it may function to protect a stored set of game cards from accidental damage, or both.

If an enhanced card is used with card reader 12 to provide for a branching storyline game, it may be inserted into an activation slot 28 on card reader body 20. The activation slot might also be known as a card receptacle. One portion of the activation slot may be configured as a display window 22, shown in FIG. 2, allowing an image 32 or 33, or other decorative addition, on an inserted enhanced card to be viewed by a game player when the enhanced card is inserted into the electronic card reader. In such an embodiment, display window 22 may be configured as a translucent or transparent material. Alternatively or additionally, display window 22 may be configured as an electronic display 23 suitable for displaying game-related or other entertaining images or information. If present, an electronic display 23 may be operatively connected to internal electrical components 27 by way of circuitry 21. An activation slot 28 on card reader body 20 may be configured to be smaller than storage compartment 29, for the purpose of holding a single inserted enhanced card. Activation slot 28 may be configured such that some portion of its interior contains card guides suitable for holding an inserted enhanced card firmly in place. The described card guides may also be configured to facilitate coupling contact between an inserted enhanced card and one or more electrical or optical contacts (not shown) in circuit 21 in an interior of the activation slot, if present. Contacts between an enhanced card and an electronic card reader may provide for communicative connections between enhanced card 30 and card reader 12, such that the card reader may access stored data on an enhanced card and utilize that data during a branching storyline game. Positive coupling between a set of electrical contacts on the enhanced card and electrical contacts on the card reader may be reflected to a game user by way of an audible “click” when the enhanced card is inserted into a card reader, or by way of a tactile sensation, or by way of an audio confirmation projected by the card reader, or any other appropriate means.

If an enhanced card 30 has been inserted into an activation slot 28 of an electronic card reader 12, stored data on the enhanced card may be accessed by the electronic card reader and used to portray branching storyline game-related or other entertaining items encoded therein. Included in the branching storyline game-related items may be some or all of story text, sound effects and instructions for a game player to read a standard card. Branching storyline game-related items may be communicated through the audio output 25. For example, at a given point in a branching storyline game a user of the electronic card reader may need to make a choice regarding further progression of the game, and the electronic card reader may activate an audio output function to relay this information to the user. The audio output of the card reader may relay instructions provided by the electronic card reader regarding which game buttons 24 may be depressed to make a given choice in branching storyline game. Alternatively or additionally, the audio output may relay instructions to a player regarding which standard or enhanced card may need to be utilized to continue a given storyline. However, not all audible signals need be directly related to an activity currently being related in the branching storyline game.

Audio output 25 may be configured to provide audio information to a game user through any appropriate medium. For example, audio output 25 may be configured as one or more speakers, used to directly project game-related or other entertaining audible information. Alternatively, or in addition, audio output 25 may include a headphone jack, to which a game user may connect speakers, headphones, or any other appropriate device. As another alternative, audio output 25 could be configured as a communications module, available commercially under the proprietary name Bluetooth™, which could provide a wireless information signal to a game user's Bluetooth™-compatible headphones, external speakers, computer, or other appropriate device.

A number of game buttons 24 may be provided on a card reader body 20 and may provide for game user input into the electronic card reader. There may be one button, or there may be a plurality of buttons. Each of the one or more game buttons 24 may have an associated button display window 26. A button display window may be configured as a translucent or transparent window that allows a game user to view an interior space of the electronic card reader body 20. As one example, button display windows 26 may be configured to allow a game user to view a portion of a surface of an enhanced card 30 when the enhanced card is fully inserted into an activation slot 28 on electronic card reader body 20. In an illustrated embodiment, there may be four game buttons 24 on the surface of electronic card reader 12, and each game button is associated with a button display window.

To provide for game user input into card reader 12, game buttons 24 may be operatively connected to some or all of the internal electrical components 27 of the electronic card reader. Game buttons 24 may allow a player to choose or alter an operation of the internal electrical components of the electronic card reader and, thus, influence the progress of a branching storyline game. For example, in an illustrated embodiment, the disclosed game components may be used to play a branching storyline game. At a “branch point” in the branching storyline game, a player may be instructed to depress a subset of the buttons, or to depress all of the buttons in a certain order, so that a next direction in a branching storyline may be determined. Depending upon the identity of game buttons 24 pushed, or the order in which they were pushed, electronic card reader 12 may relay to the game player one or more instructions regarding which standard or enhanced card may next be used in the storyline. Alternatively, the electronic card reader may relay to the player instructions stating that a different enhanced card is needed to continue the chosen storyline.

An illustrated embodiment of a storytelling game utilizes one or more enhanced cards containing stored data, a plurality of standard cards, and a card reader. The illustrated embodiment may require that the card reader contain integral electronics to present a story to a game player. For example, the card reader may be configured with a microprocessor, associated memory, and software. Also, the card reader's integral electronics may include electrical connections that allow an interface to be maintained between an enhanced card and the card reader's microprocessor circuitry. Such an electrical connection may allow the card reader to access and decipher stored data resident on the enhanced card. Electrical components in the card reader may provide a human-cognizable output to be projected from the card reader and computing circuitry in the card reader may allow for user inputs to the device via, for example, buttons 24 on a surface of the card reader.

As noted earlier, a plurality of game cards may be part of a storytelling game. A set of game cards useful for telling a story might consist of one or more enhanced cards 30 (FIG. 3A) and one or more standard cards 40 (FIG. 3B). An enhanced card, as described above, may include a memory 39 configured to store data suitable to be read by a card reader. In addition, an enhanced card may have one or more images 32, 33 on one or more of its surfaces and the enhanced card may be printed with one or more distinctive icons 38. Each enhanced card may also have text 36 on at least one of its surfaces, perhaps in the form of a story title, identifying the enhanced card as belonging to a group of cards making up a branching storyline game. Icons 38 on the surface of an enhanced card may be used in a branching storyline game. For example, icons 38 may be visible through button display windows 26 if an enhanced card containing those icons is fully inserted into an activation slot in an electronic card reader body. Upon card insertion, a given icon may become associated with a game button directly below the button display window 26 through which the icon is visible. At a branch point in a branching storyline game, a game player may be instructed to depress buttons associated with at least one of the icons to continue a given storyline or to choose a new storyline.

As noted, enhanced cards 30 may contain a memory accessible by an electronic card reader containing the appropriate internal electrical components. Storage of data in the enhanced card may be accomplished through the use of volatile memory, nonvolatile memory, or any other appropriate memory medium. An electronic card reader and an enhanced card may have the same, similar or different internal electrical components. As an example, both an electronic card reader and an enhanced card may use a voice integrated circuit chip such as one commercially available and identified as EMC EM55551, capable of storing 94.5 seconds of 8 k sound. In an illustrated embodiment, enhanced cards 30 contain an embedded digital memory upon which data may be stored and made available for access by an electronic card reader, and the enhanced card and the electronic card reader utilize the described voice integrated circuit chip. Additionally, the enhanced card may include internal electrical components 34 and circuitry 35 operatively connected to memory 39.

The outward appearance of standard cards 40, shown in FIG. 3B, may be similar to the outward appearance of the enhanced cards 30 seen in FIG. 3A. Unlike an enhanced card or cards, however, a standard card 40 may not be configured to include a memory for storing electronic data. Therefore, enhanced cards and standard cards may be configured to share a common size or shape but enhanced cards and standard cards may not always share a common thickness; to accommodate a memory for data storage, an enhanced card 30 may be of greater thickness than a standard card 40. Standard cards 40 may have text 46 visible upon one or more of their surfaces. Such text may be a story-related short phrase, or it may be a compendium of phrases, or it may be a story title. The story-related text on a standard card may merely identify a card as belonging to a group of cards, or the text may relate a portion of a story in a branching storyline game. As shown in FIG. 3B, a standard card may also contain one or more images 42, 43 on one or more of its surfaces. An image or images 42, 43 may be the same as or different than one or more images 32, 33 present on an enhanced card 30 (see FIG. 3A).

Image or images 42, 43 may identify a standard card as belonging to a group of cards. Alternatively, or in addition, image or images 42, 43 may contain story-related information. Similar to the icon or icons 38 which may be present on an enhanced card 30, a standard card 40 may contain one or more icons 48 on at least one of its surfaces. Such icons may be used by a player to decide on a next direction of a story related in a branching storyline game, as described below. Alternatively, or in addition, such icons may have entertainment value to a game player. As standard cards 40 may be provided as a deck of a plurality of cards, each standard card may have a unique identifying indicium 44 upon one or more of its surfaces. In an illustrated embodiment, the unique indicium 44 upon one or more surfaces of a standard card is a unique number, applied to each standard card to differentiate it from all other standards card in the same deck.

Returning to a discussion of an enhanced card 30, data residing on the enhanced card may take any suitable form for being read by a card reader 12. The stored data of an enhanced card may embody a story told in multiple segments with each story segment being stored on a separate enhanced card 30 and being related to a subset of standard cards 40. Alternatively, an enhanced card may provide for the telling of a complete story, with a number of enhanced cards and standard cards making up a set of related or unrelated stories. In an illustrated embodiment of the present disclosure, a branching storyline game may be embodied in flash memory storage on a single enhanced card 30 and the branching storyline game may utilize all standard cards 40 in a deck of cards. A single enhanced card and a plurality of standard cards may form a complete deck of cards for a branching storyline game, as discussed below. In the illustrated embodiment, electronic card reader 12 may include any electrical components suitable for reading the flash memory contained in an enhanced card 30.

The data on an enhanced card may embody a story that directs a game player through use of a set of standard cards. For example, in a linear storytelling system, a storyline embodied in the data on an enhanced card may require that a user read through a set of standard cards in a pre-defined order to relate a story in consecutive parts. Alternatively, a storyline embodied in the data on an enhanced card may direct a user through a set of standard cards in a nonlinear, or branching, manner. In an illustrated embodiment of the present disclosure, a storyline stored in the data of an enhanced card may develop as a “branching story” where each story segment may be related to a plurality of other story segments. In a branching storyline game, as each story segment is completed it may be possible for the user of an enhanced card 30 and electronic card reader 12 to choose which one of a number of possible segments will come next in a particular story.

As a way of knowing which one of a plurality of standard cards contains a next segment of a particular story, each standard card may have printed upon one of its surfaces a distinct indicium 44 or text 46, as noted above. In a set of standard cards making up a branching storyline game, text 46 may be a branching storyline game title printed upon at least one surface of each card. However, each of the standard cards making up a storyline may also have a different indicium 44, for example, a unique number, printed upon at least one of its surfaces such that it may be recognized as distinct from all other standard cards in a deck. At the end of a story segment, a player of the branching storyline game may be given a plurality of choices as to how the game may continue. Depending upon a choice made by the player, and the game buttons subsequently manipulated, the player may be instructed by the electronic card reader to pick one uniquely-numbered card over another for use as the next story segment.

For example, it may be that a story segment ending with a standard card numbered “23” has a character seeing an object on the ground. A player of the storytelling game of the present disclosure may be given a choice as to possible outcomes of this story segment and the identity of game buttons 24 the player should push on card reader 12 relating to each possible outcome. If the player chooses to have the character pick up the object, the player may push buttons related to that first choice and may be directed by the electronic card reader to next read a standard card numbered “15”; if the player would like the character to ignore the object, the player may push buttons related to that second choice and may be directed by the electronic card reader to next read a standard card numbered “37”. The branching storyline game may then progress via the chosen story segment, with an overall outcome of the story being determined by the choice of story segments made at each branch point.

In addition to being distinctly numbered, each enhanced card 30 and each standard card 40 may have upon one or more of its surfaces a set of unique icons 38, 48 and/or text 36, 46, as noted earlier. Any icons or text on the surface of a given card may be placed on the surface through printing, embossing, etching, etc. Text 36 or 46, as noted earlier, may include some or all of a story segment related to that particular card, and could be used in conjunction with a distinct indicium 44 on the card to help differentiate the card from other cards. A set of unique icons 48 printed on a face of each card may be used to identify a card and/or to facilitate game play.

Icons 38 on an enhanced card may be oriented such that they align with a set of button display windows 26 on electronic card reader 12 (as noted earlier), and they may be used by a player when the player makes a choice during a story segment. Icons on one or more standard cards may be organized in ways that relate to different choices which may be made during a branching storyline game. For example, when a choice may be made within, or at the end of, a story segment, a player may be instructed to depress game buttons 24 on an electronic card reader associated with a particular set of icons on an enhanced card to determine a next direction a story will take. If this action is performed during a story segment, then it may be that the story will take a new direction automatically. If this action is performed at the end of a story segment, then it may be the case that a player will be told an identity of a next standard card 40 which needs to be read, or a next enhanced card 30 to be inserted into card reader 12, for a desired storyline to unfold (as described above).

Though enhanced cards 30 and standard cards 40 may be designed such that their surface appearances are distinct from each other, it may be preferable for all the cards of a deck to have similar shapes and sizes. Configuring the cards of a deck with a common size and shape may make it easier for them to be stored as a group in, for example, a card-carrying case. Alternatively, having the standard cards 40 and enhanced cards 30 configured with a similar size and shape may mean that the electronic card reader could be designed with a storage compartment 29 in an electronic card reader body 20 which could carry some or all of the cards when they are not in use.

Having described the details of the disclosed game components, there follows a brief description of game play in a branching storyline game utilizing those components. In an illustrated embodiment, an electronic card reader and a set of cards of the present disclosure may be used to play a “Branching Storyline” card game. An object of the game may be to play from a set of cards, including both enhanced and standard cards, and progress through a story while choosing a direction for a storyline at a number of branch points. To do this, one or more game players may read a story segment from a standard card and enter a code pictured on the standard card to follow a path through a story and progress on a “journey”. Along the way, the one or more players may enjoy a sense of adventure and may accumulate clues that lead them to an ending for the story. An ending to the story may involve a happy or sad ending (an “ultimate” ending), or it may lead to a bonus (“Easter egg”) story. In an illustrated embodiment, the goal of a branching storyline game may be to reach a winning ultimate ending that may be denoted by some combination of text, audio messages, visual displays, etc.

In summary, a method of playing a branching storyline game, may include a step of inserting a card into a card reader, where inserting the card into the card reader causes the card and the card reader to become operatively coupled. The method may also include the steps of receiving a first set of choices from the card reader, making a first choice from the received set of choices, and entering a first data into the card reader representing the first choice made. Such a method may be followed repetitively by a game player to progress from a beginning to an ending of a branching storyline game.

A branching storyline game may be played from a set of cards (a “story deck”) that is one of a plurality of available sets of cards. Because a game according to the present disclosure is provided in a card format, it may be played in one location or it may be portable for use during travel. Also, story decks portraying partial or complete stories may be acquired separately from each other to allow many stories to be used with a single card reader. Alternatively, a single story deck may be used with a plurality of card readers. In addition, the use of many enhanced and/or standard cards in a game according to the present disclosure may allow one or more players to participate in a game at the same time. One or more players might take turns reading story text, deciding which story branch to follow, and entering icon codes into an electronic card reader. Each change in a story direction, decided upon by one or more of the players, may be communicated from an electronic card reader to the players through use of audio or visual effects which may include one or more types of entertaining sounds, voice effects, images, etc.

As noted earlier, a branching storyline game may be related by an electronic card reader and a set of cards. The set of cards of a branching storyline game of the present disclosure may include both standard cards and enhanced cards. The standard cards may further include a set of cards relating a known story and a set of “Easter egg” cards relating a hidden story. A set of enhanced cards may include one or more memory cards providing content for a given branching storyline game and/or a “dummy” enhanced card that assists a game player in following an Easter egg story. Use of a set of described standard and enhanced cards may be facilitated by an electronic card reader.

A set of standard cards for a given branching storyline game may have cards with text and/or various images printed upon one or more of their surfaces. Printed information on a standard card may include one or more of: story text related to a game being played; a title of a story; an identifying number for the card; and various icons. Each of the cards of a set may share, on a first surface, a common image but each card may have a unique number. However, on a second surface, the cards of a set may each have a distinct combination of story text, images, code icons, an identifying number, or any other interesting visual symbol.

An enhanced card for a given story or a “dummy” enhanced card for an Easter egg story may have text and/or various images printed upon one or more of its surfaces. Printed information on a first surface of an enhanced card may include an image common to all the cards (standard and enhanced) used for a given story, as well as icons for use with an electronic card reader. Such icons may be configured to align with button display windows on the electronic card reader when the enhanced card is fully inserted into the electronic card reader. On a second surface of an enhanced card there may be any combination of story text, images, and/or instructions about card care and card use. A dummy enhanced card for an Easter egg story may have a same or similar outward appearance as an enhanced card, but the dummy enhanced card may not have an internal memory for storing story-related data.

An electronic card reader may be a self-contained unit which allows for storage of a set of cards when they are not in use. Loading an enhanced card or a dummy enhanced card into an activation slot on the electronic card reader may load new story content for a branching storyline game into the electronic card reader. In addition, inserting an enhanced card into the electronic card reader may align new icons, appropriate to a branching storyline game related to the inserted enhanced card, with a set of button display windows on a side of the card reader. The electronic card reader may generate audible output and/or sound effects, after insertion of the enhanced card, when one or more appropriate buttons are pushed at appropriate times in the branching storyline game.

To begin game play, one or more game players may load either a standard enhanced card or a dummy enhanced card into an electronic card reader. Loading an enhanced card into the electronic card reader may allow the electronic card reader to access and/or download branching storyline game-related information contained in a memory of the enhanced card. For example, an enhanced card provided with a deck of standard cards may contain in its memory all the sound and/or visual effects unique to the story related by the deck of standard cards with which it is provided. Loading a dummy enhanced card into the electronic card reader may “unlock” branching storyline game-related information contained within a memory of the electronic card reader itself related to an Easter egg story.

Loading either an enhanced card or a dummy enhanced card into an electronic card reader may “wake” the electronic card reader from a resting state if the electronic card reader has not been in use for a given period of time. Or, the electronic card reader may be turned on through use of a power switch. The electronic card reader may enter the resting state when a branching storyline game has not been played for some time; such a resting state may conserve electrical power in the electronic card reader, particularly if the electronic card reader is being powered by a plurality of batteries. For the electronic card reader to be completely activate, even after being woken, an enhanced card or a dummy enhanced card may need to be inserted into an activation slot of the electronic card reader such that a set of one or more icons on a surface of the enhanced card is visible through a set of button display windows on the card reader. Once the electronic card reader has been activated, and an enhanced card inserted, a player may be given an option to begin a new branching storyline game or to continue a branching storyline game that was previously begun.

Whether a player chooses to start a new game, or continue a previous one, the player may arrange a set of standard cards of a deck so that the standard cards are easily accessible. For example, a player may arrange the standard cards into a grid-like arrangement on a table, floor, or other suitable surface. Alternatively, a player may place the standard cards in numerical order in a single stack.

To play a branching storyline game, one or more players may begin a story by reading story text on a first standard card. Such story text will typically lead the players to a branch point in the story; a branch point being a point in the story where the one or more players must make a decision about a further direction of the branching storyline game. Upon making a choice of which story branch to follow, the player or players may enter into the electronic card reader an icon code which relates to the chosen story branch. Initial insertion of an enhanced card into the card reader may have arranged icons behind a set of button display windows above a set of card reader buttons, making it possible to enter a given icon code. To enter an icon code into the electronic card reader, players may depress game buttons, on a side of the card reader, corresponding to a code on the standard card.

An electronic card reader may process an entered icon code and respond with a set of audio instructions. Alternatively, if a display window on the electronic card reader has been configured as an electronic display, then the instructions may be related via the electronic display as visible instructions. A set of audible instructions from the electronic card reader may be story-related sound effects, or they may be human-cognizable directions related to a continuation of a branching storyline game. For example, the electronic card reader may instruct one or more players on the identity of a next standard card which may be read to continue a given branching storyline game. The player or players may then read a provided story text on the next standard card and make further choices concerning a direction the story may take. By paying attention to various clues and hints on each used standard card (which clues may be provided in either or both of the story text and any accompanying illustrations) and making choices at branch points in the story, the one or more players may continue the branching storyline game to an ultimate ending. If a game player forgets an output given by the electronic card reader, for example, a sound effect played by the electronic card reader or any other output, the player may press a memory recall button on the electronic card reader to repeat the last-given electronic card reader message.

An ending of a branching storyline game may not be obvious from a provided text or visual clue available on a given standard card, and may only be announced as an audible or visual output from an electronic card reader. The ending of a branching storyline game may be an ultimate ending (perhaps a “happy ending”), it may be a demise of a character in the branching storyline game, or it may be a branch to an Easter egg story. If the ending of a branching storyline game is the ultimate happy ending, that ending may signify overcoming a series of trials or deciphering of a number of clues, leading to successful solution of a mystery or completion of an adventure. If the player reaches the happy ending, an electronic card reader may signify that occasion by playing a celebratory audio message, or taking some other appropriate action. If the ending of a branching storyline game is the demise of a character in the branching storyline game, then that ending may signify unsuccessful completion of an adventure, and it may be an occasion for the one or more players to begin the branching storyline game anew and try again to solve the many riddles, puzzles and clues in the branching storyline game. If the player reaches an unhappy ending, the electronic card reader may signify that ending by relaying a message instructing the player to try the branching storyline game again from the beginning, or by conveying any other appropriate message. If the ending of a branching storyline game is a branch to an Easter egg story, then the player or players may be invited to begin a new, bonus storyline.

An Easter egg story in a branching storyline game may be a bonus story utilizing a set of standard or enhanced cards unique to the Easter egg story. Alternatively, or in addition, the Easter egg story may use a subset, or a complete set, of standard or enhanced cards from other branching storyline games. As with other branching storyline games, a set of standard cards and a single enhanced card may make up an Easter egg story. However, it is possible that the enhanced card used with an Easter egg story may be a dummy enhanced card, such that it does not contain a memory encoding branching storyline game-related items but instead serves to activate a stored branching storyline game residing in the memory of an electronic card reader. As another possibility, the Easter egg story may utilize an enhanced card from another branching storyline game, along with its associated memory. A subset of standard cards needed to play the Easter egg branching storyline game may be provided with a full set of standard and enhanced cards needed to play a different branching storyline game, such that by accumulating a number of branching storyline games a player may accumulate a complete set of cards for use with the Easter egg branching storyline game. Also, an Easter egg branching storyline game may be designed such that relating the Easter egg branching storyline game requires use of a number of standard or enhanced cards from more than one other branching storyline game. For example, if a given Easter egg branching storyline game requires seventy-eight standard cards and a single enhanced card to make a story game, then it may be that ten standard cards specific to the Easter egg storyline may be provided with each of six branching storyline games, while an additional three cards from each of those branching storyline games may complete the set.

In an illustrated embodiment, a branching storyline game may be provided in four parts, with the first three parts being story chapters and the fourth part being an Easter egg story making up the fourth and final chapter. Standard story chapters one through three may each contain a subset of a full set of cards needed to relate chapter four. For example, of seventy-nine standard cards needed to relate chapter four, nine may come from chapter one, thirty-five from chapter two, and thirty-five from chapter three. A constituent set of cards for the Easter egg story may be allocated in any proportion among story chapters. Typically, story chapters may be followed in a predefined order by a game player, or they may be followed in any desired order. However, in an illustrated embodiment, a game player may be required to successfully complete a set of numbered story chapters in a defined order before the final Easter egg chapter may be begun.

In an illustrated embodiment, an enhanced card provided for an Easter egg branching storyline game is a dummy enhanced card which, as discussed. earlier, gives an outward appearance of an enhanced card but which lacks integral memory. In the case of an Easter egg branching storyline game, the dummy enhanced card may be used to “unlock” a stored memory within an electronic card reader. The unlocked memory within the electronic card reader may provide for a set of game instructions and sound effects to be used with the Easter egg branching storyline game. As an alternative, or in addition, the embedded memory of the electronic card reader may keep track of the completion of standard story chapters by a game player. If the game player completes a given number of branching storyline game chapters, then the electronic card reader may allow the game player to begin the Easter egg chapter and, therefore, attempt completion of the branching storyline game. The memory of an electronic card reader may store all required sound effects or other information for the Easter egg chapter, or such stored information may reside in a portion of the memory of an enhanced card used with another story chapter.

As noted, an entire Easter egg branching storyline game may include standard cards unique to the Easter egg story and a subset of standard cards provided from each of a number of other branching storyline games. It may be that a number of complete branching storyline games may be provided separately from an electronic card reader. This may allow a player to have a single electronic card reader which may be used for playing a number of different branching storyline games. Multiple branching storyline games may have distinct themes, or they may each provide for continuation of a branching storyline game which seemed complete upon first being played. A self-contained branching storyline game may have the same or similar characteristics of game play and objectives as a branching storyline game provided with an electronic card reader. In addition, the self-contained branching storyline game may include one or more enhanced cards provided with the self-contained game to store necessary game instructions, sound effects, and/or audio or video messages.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. An amusement system for relating a story with a branching storyline, comprising:
a set of cards, including a plurality of indicia cards each including a plurality of indicia relating to different branches of a storyline; and
a card reader unit, comprising:
a card receptacle adapted to receive one of the cards with the indicia visible;
at least a first input device manually operable for identifying a selected one of the indicia;
at least a second output device for outputting audio signals related to the storyline;
a memory for storing data associated with a storyline and instructions relating to the storyline; and
a processor coupled to the input device, output device, and memory, the card reader unit being configured to output on the output device information about a storyline, receive on the input device information identifying a selected indicia, and outputting further information on the output device determined by the identified indicia.

2. The system of claim 1, wherein the card reader unit further includes at least a first window for exposing the plurality of indicia when one of the cards is received in the card receptacle.

3. The system of claim 2, wherein the card reader unit further includes a plurality of the input devices, with each input device being aligned with a corresponding indicia when a card is received in the card receptacle.

4. The system of claim 3, wherein the set of cards includes at least one data card having a memory configured to store information relating to the storyline, the card receptacle is adapted to receive the data card, and the processor is coupled to the receptacle for receiving information stored on the data card when the data card is received in the card receptacle, the card reader unit being further configured to output on the output device information about a storyline determined at least in part on the information received from the data card.

5. The system of claim 1, wherein the set of cards includes at least one data card having a memory configured to store information relating to the storyline, the card receptacle is adapted to receive the data card, and the processor is coupled to the receptacle for receiving information stored on the data card when the data card is received in the card receptacle, the card reader unit being further configured to output on the output device information about a storyline determined at least in part on the information received from the data card.

6. The system of claim 5, wherein the at least one data card stores at least a portion of the storyline.

7. The system of claim 6, wherein the card reader unit is further configured to instruct a user to replace the data card with an indicia card in the card receptacle, and to select an indicia from the plurality of indicia on the card in the card receptacle.

8. The system of claim 1, wherein the cards are uniquely identified.

9. A set of cards for use as part of an amusement system for relating a story with a branching storyline, the amusement system further including a card reader unit configured to output information about a storyline, receive information identifying a selected indicia, and outputting further information determined by the identified indicia, the set of cards including a plurality of indicia cards each including a plurality of indicia relating to different branches of a storyline that are selectable by a user when a card is received in the card reader unit.

10. The set of cards of claim 9, wherein the set of cards includes at least one data card having a memory configured to store information relating to the storyline, and configured to be received by the card reader unit for determining operation of the card reader unit based at least in part on the information stored on the at least one data card.

11. The set of cards of claim 10, wherein the at least one data card stores at least a portion of the storyline.

12. A method of playing a branching storyline game, comprising:
inserting a first choice card identifying a first set of choices relating to a storyline into a card reader, wherein inserting the card into the card reader causes the card and the card reader to become operatively coupled;
receiving from the card reader the first set of choices relating to the storyline;
selecting a first choice from the received set of choices; and
entering a first data into the card reader representing the selected first choice.

13. The method of claim 12, further comprising:
inserting a second card identifying a second set of choices relating to the storyline and determined at least in part by the entered first choice; and
receiving from the card reader the second set of choices;
selecting a second choice from the received second set of choices; and
entering a second data into the card reader representing the selected second choice.

14. The method of claim 13, further comprising:
inserting a data card containing storyline data into the card reader;
reading storyline data from the data card;
outputting information identifying a specific choice card to insert into the card reader based at least in part on the read storyline data.

15. The method of claim 12, wherein inserting a first choice card includes aligning each of a plurality of indicia on the first choice card with a corresponding plurality of input devices on the card reader, and wherein entering a first data includes activating an input device aligned with the indicia corresponding to the selected first choice.

16. A method of playing a branching storyline game, comprising:
providing first game information to a game player;
providing a first set of choices relating to a storyline to the game player;
receiving a first choice from the game player; and
providing a second game information to the game player, the second game information being determined at least in part by the received first choice.

17. The method of claim 16, further comprising:
providing a second set of choices relating to the second game information to the game player;
receiving a second choice from the game player; and
providing a third game information to the game player, the third game information being determined at least in part by the received first choice.

18. The method of claim 16, wherein providing a first set of choices includes receiving a choice card identifying a first set of choices relating to a storyline, and displaying indicia representative of the first set of choices.

19. The method of claim 18, wherein receiving a choice card includes inserting a choice card having an indicium associated with each choice into a card reader, and displaying indicia includes aligning each indicium associated with a choice on the choice card with an input device, and receiving a first choice includes activating the input device associated with the indicium associated with a selected choice.

20. The method of claim 16, wherein providing first game information includes providing a data card having a memory containing at least the first game information, inserting the data card into a card reader, reading the data from the data card, and outputting the first game information.
